(19) United States
(12) Patent Application Publication
(10) Pub. No.: US 2009/0274192 A1
(43) Pub. Date: Nov. 5, 2009

(54) REPLACEABLE ELECTRONIC CLINICAL THERMOMETER

(76) Inventor: Chao-Man TSENG, WuKu Industrial Park Taipei (TW)

Correspondence Address: HDLS Patent & Trademark Services, P.O. BOX 220746, CHANTILLY, VA, 20153-0746, US

(21) Appl. No.: 12/397,622

(22) Filed: Mar. 4, 2009

Related U.S. Application Data
(63) Continuation-in-part of application No. 12/113,957, filed on May 2, 2008, now abandoned.

(51) Int. Cl. G01K 7/00; G01K 1/00

(52) U.S. Cl. 374/170; 374/208; 374/E01.001; 374/E07.001

(57) ABSTRACT

A replaceable electronic clinical thermometer includes a control portion and a plurality of sensor portions. The control portion and sensor portions are installed with respective connecting units. The control portion has a first connecting unit, a control portion, a display unit and a circuit unit. The circuit unit is electrically connected to the first connecting unit. A sensor unit is installed to one end of the sensor portion, and the other end of the sensor portion is installed to a second connecting unit. The sensor portion is electrically connected to the second connecting unit. The first connecting unit has a plurality of pins which are printed upon a printed circuit board or are metal strings. Each of the pins is exposed and installed to the outer periphery of the first connecting unit. The second connecting unit has a plurality of pins corresponding to the pins of the first connecting unit.

### RELATED APPLICATIONS

U.S. patent applications Ser. No. 12/113,957 filed on May 2, 2008 is submitted as related applications.

### FIELD OF THE INVENTION

The present invention relates to electronic clinical thermometers, and particularly to a replaceable electronic clinical thermometer, in that by the connection of pins to detect which kind of the sensor portion is used.

### BACKGROUND OF THE INVENTION

Before the invention of electronic clinical thermometers, mercury thermometers are widely used for measuring temperatures of human bodies. The mercury thermometer is based on the principle of heat expansion and cool contraction. Generally, a mercury thermometer has a glass casing receiving mercury therein. A size of the mercury thermometer is varied based on the applications, such as it is used to measure the temperatures of mouths, the thermometer is a long slender shape for measuring the temperature of mouths. For anus, it is short. The mercury will expand due to heat and thus lift upwards. The user can know the temperature from the scale in the thermometer.

The mercury thermometer is easy to crack and the view angle is small. Furthermore, mercury is harmful to human body and environment. The mercury is forbidden gradually. Thus, electronic clinical thermometers are widely accepted nowadays.

Generally, the principle for the measurement of electronic clinical thermometer is that: a count circuit calculates a base time period for a specific time of an oscillation circuit formed by a reference resistor and a capacitor connected to the counting circuit externally. Then the circuit is switched to a temperature sensitive resistor and the capacitor above mentioned. The number of times for the oscillation between the temperature sensitive resistor and the capacitor above mentioned is calculated. The result is operated in a microprocessor and is converted to a data signal which is then transferred to a display.

Since technology has improved greatly, for home used electronic clinical thermometers, it has no doubt to the sanitation of human body, but in medical locations the electronic clinical thermometers are used for many patients, even they are sterilized in alcohol, while the people do not fully believe the safety use of the electronic clinical thermometers. Thus to avoid infection, the electronic clinical thermometers are sterilized before use with a long and tedious process.

To reduce the electronic clinical thermometers used, a separable electronic clinical thermometer is developed. In that, a USB (universal serial bus) is used to separate a probe and a control body. However the USB occupies a large space in the electronic clinical thermometer and thus it is not practical.

In a further improvement, U.S. Pat. No. 7,293,915, “Assembly method and structure of an electronic clinical thermometer”, the electronic clinical thermometer is divided into a separable unit and an assembled unit. A unit is lack of at least two electronic elements which are installed at another unit. In use the two units are assembled so as to have the whole components. Thus the electronic clinical thermometer can be used for measuring the temperatures of human bodies.

However the different measuring portions of human bodies needs to adapt different measuring formulas, for example forehead, anus, and mouth have different measuring formulas. To be adjusted conveniently, the programs and circuits also different. However in the prior art structure, only the probe and control body is separable. As they are combined, the kinds of the probes can not be identified. To have the identification function, generally, a sensing end is added with a transmitter and the body is added with a receiver. However these prior art structures need extra software, loops and loops and thus cost is high and more space is need. It is not economic.

### SUMMARY OF THE INVENTION

To achieve above object, the present invention provides an electronic clinical thermometer with no USB connection and less space is used. The kind of the sensor portion can be known and the thus an operation mode can be determined.

To achieve above object, the present invention provides an electronic clinical thermometer which includes a control portion and a sensor portion. The sensor portion and the control portion are connected by a connecting unit. Thereby by the connecting unit, the sensor portion is connectable to or detachable from the control portion. The control portion is installed with at least one first connecting unit, a control unit, a display unit and a circuit unit. The control portion provides functions of actuating, de-actuating, switching operation modes, and changing setting. The circuit unit is electrically connected to the first connecting unit. A sensor unit is installed to one end of the sensor portion, and the other end of the sensor portion is installed to a second connecting unit. The sensor unit is electrically connected to the second connecting unit. The first connecting unit has a plurality of pins which are printed upon a printed circuit board or are metal strings. Each of the pins is exposed and installed to the outer periphery of the first connecting unit. The amount of the enabled pins of the second connecting unit is smaller than that of the first connecting unit. By pin connection between the pins of the control portion and the pins of the sensor portion, the sensor portion is electrically connected to the control portion.

In the present invention, the pins are exposed and installed to the outer periphery of the connecting unit for reducing the housing space in installation. Not only the cost is saved, but also the volume of the electronic clinical thermometer is reduced. Furthermore, the two outermost pins are used to determine whether the electrically connection is correct so as to determine whether the sensor portion is correctly electrically connected to the control portion. Moreover different portions of human body have different temperatures and thus the operation formulas are also different. In the present invention, by the pin positions and the pin number of the second connecting unit being smaller than that of the first connecting unit, the first connecting unit and second connecting unit can be formed as an open or close circuits so that the circuit unit can determine the kind of sensor portion and thus can determine the operation mode of the sensor portion.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is a schematic view showing the electrically connection of the pins of the connecting unit.

FIG. 3 is an assembled schematic view of the present invention.

FIG. 4 is an explosive schematic view showing different sensor portion according to the present invention.

FIG. 5 is a schematic view showing the connection of the pins of the connecting units in FIG. 4.

FIGS. 6 and 7 are exploded view and assembled schematic view about the connection of metal strings.

FIG. 8A is a schematic view of a signal switching portion of another embodiment.

FIG. 8B is a schematic view of the signal switching portion of another embodiment.

FIG. 8C is a schematic view of the signal switching portion of another embodiment.

FIG. 9 is a block diagram of the control portion according to the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

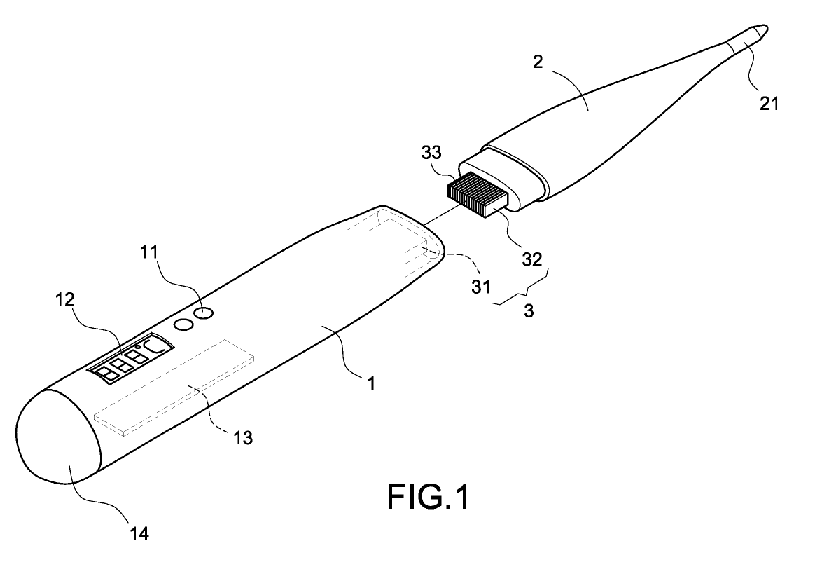

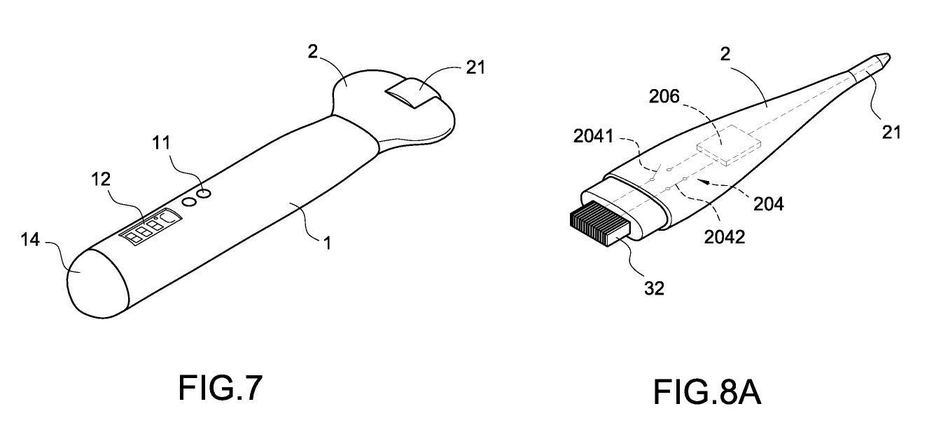

The present invention relate to a replaceable electronic clinical thermometer, as shown in FIGS. 1 to 9, the body of the clinical thermometer includes a control portion 1 and a plurality of sensor units 21 which are connected by a connecting unit 3.

The control portion 1 has a handle 14 on one end thereof. Another end of the control portion 1 with respect to the handle 14 has a first connecting unit 31. The control portion 1 has a plurality of control units 11, a display unit 12 and a control portion 1 on a surface of the handle 14. The control units 11 are electrically connected to a circuit unit 13, and the circuit unit 13 has a main controller 130. The control units 11 provide functions of actuating, de-actuating, switching operation modes, and changing settings. The display unit 12 is electrically connected to the circuit unit 13 for displaying measured temperature data, operation modes, and operation statuses, etc. The control unit 11 is a control center of the electronic clinical thermometer to provide functions of calculation, setting, recording, etc. The circuit unit 13 is electrically connected to the first connecting unit 31. The circuit unit 13 is electrically connected to the sensor portion 2 through the first connecting unit 31.

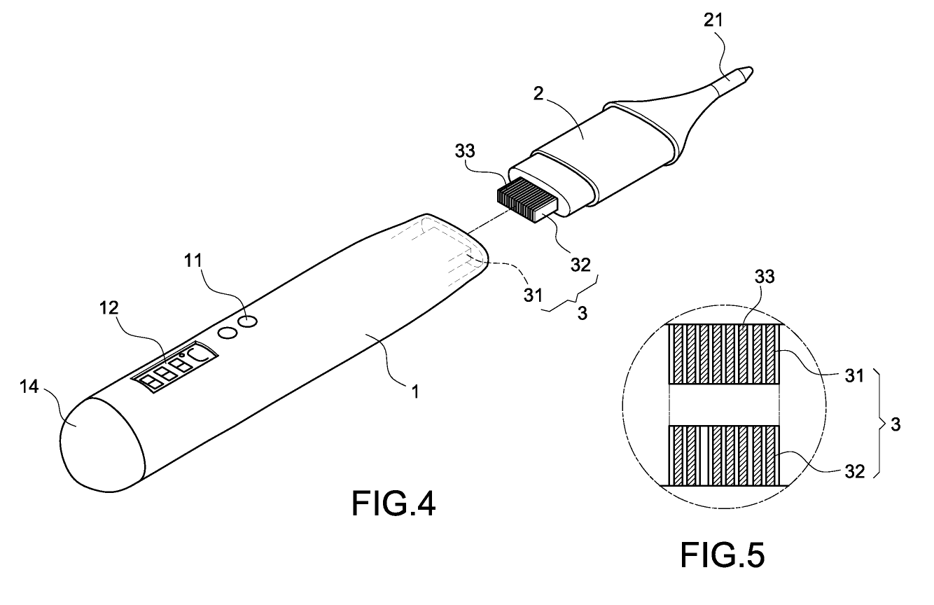

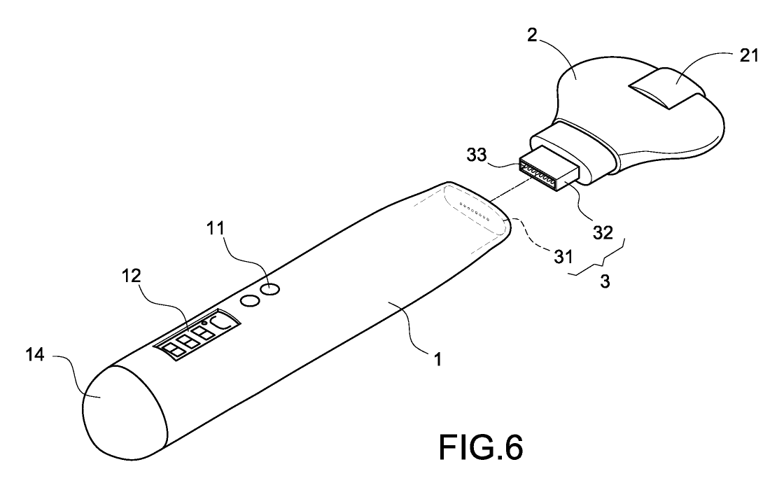

The sensor portion 2 has three different kinds of appearances. The first one is long-slender-shaped, and the corresponding sensor unit 21 has a tip end (referring to FIG. 1). The second one is short-planiform-shaped, and the corresponding sensor unit 21 has a tip end (referring to FIG. 4). The third one is flat-elliptical-shaped, and the corresponding sensor unit 21 has a flat end (referring to FIG. 6). The long-slender-shaped sensor portion 2 is provided to measure the temperature of an armpit. The short-planiform-shaped sensor portion 2 is provided to measure the temperature of an anus. The flat-elliptical-shaped sensor portion 2 is provided to measure the temperature of a tongue. One end of a sensor unit 21 is installed near a foremost end of the sensor portion 2, and the other end of the sensor unit 21 is installed to a second connecting unit 32. The sensor unit 21 is electrically connected to the second connecting unit 32, and the sensor unit 21 is electrically connected to the control portion 1 through the second connecting unit 32.

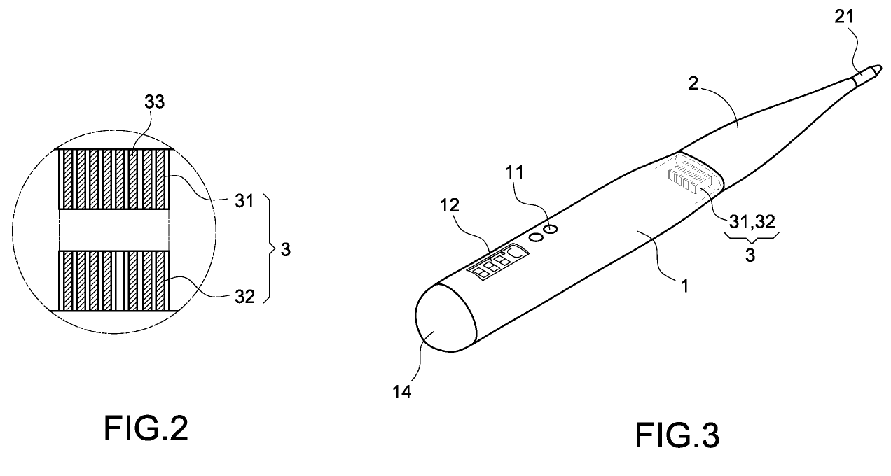

Referring to FIG. 2, the connecting unit 3 includes the first connecting unit 31 and the second connecting unit 32 which are installed to the control portion 1 and the sensor portion 2, respectively. The first connecting unit 31 is installed to one end (opposite end to the handle 14) of the control portion 1, and the second unit 32 is installed to one end (opposite end to the sensor unit 21) of the sensor portion 2. The first connecting unit 31 has eight pins 33. Each of the pins 33 is printed upon a printed circuit board (PCB) or each of the pins 33 is metal string. The pins 33 are exposed and directly installed to the outer periphery of the first connecting unit 31 and the second connecting unit 32 so as to reduce the volume for packing. The pins 33 of the second connecting unit 32 are corresponding to the pins 33 of the first connecting unit 31. By pin connection between the pins 33 of the second connecting unit 32 and the pins 33 of the first connecting unit 31, the sensor portion 2 is electrically connected to the control portion 1.

The installation of the pins 33 are illustrated in FIGS. 1 and 2. The outermost two pins 33 of the first connecting unit 31 (namely, the first pin 33 and the eighth pin 33) are used to determine whether the sensor portion 2 is correctly electrically connected to the control portion 1. Because the first pin 33 and the eighth pin 33 are at the two outermost pins, it is only necessary to determine whether the first pin 33 and the eighth pin 33 are correctly electrically connected to confirm that other pins (beside of the first pin 33 and the eighth pin 33) are correctly electrically connected.

In the embodiment of the present invention, as shown in FIG. 1 and FIG. 2, which sensor unit 21 of the sensor portion 2 is detected is according to which pin (from the second pin 33 to the seventh pin 33) of the second connecting unit 32 is disabled. Hence, the amount of the enabled pins 33 of the second connecting unit 32 is smaller than that of the first connecting unit 31. The sensor unit 21 of the sensor portion 2 is provided to measure the temperature of armpit when the fifth pin 33 of the second connecting unit 32 is disabled. When the second connecting unit 32 is electrically connected to the first connecting unit 31, the sensor unit 21 transfers measured data to the circuit unit 13 through the first connecting unit 31, the second pin 33, and the second connecting unit 32 to form a circuit loop. The fifth pin 33 of the second connecting unit 32 is not electrically connected to any one pin 33 of the first connecting unit 31, so the circuit unit 13 can detect that the sensor portion 2 is provided to measure temperature of an armpit and a corresponding mode is selected to be operated. Referring to FIGS. 4 and 5, the sensor portion 2 is provided to measure temperature of an anus, because the third pin 33 of the second connecting unit 32 is not electrically connected to any one pin 33 of the first connecting unit 31. Thus, the circuit loop formed between the first connecting unit 31 and second connecting unit 32 is different to determine which kind of the sensor portion 2 is used.

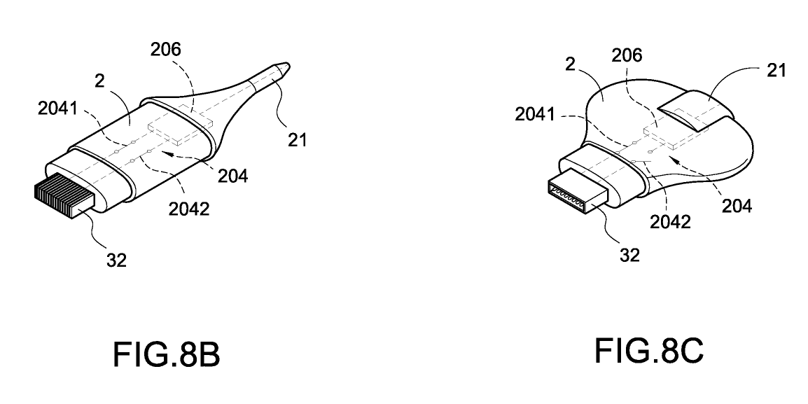

Referring to FIG. 8A, in the embodiment, the sensor portion 2 is a first sensor portion 2 which is long-slender-shaped, and the sensor unit 21 has a tip end. The sensor portion 2 further includes a signal switching portion 204 and a sensor controller 206. The signal switching portion 204 includes a first switch 2041 and a second switch 2042. The first sensor portion 2 is provided to measure temperature of an armpit. The first switch 2041 and the second switch 2042 of the first sensor potion 2 are controlled by the sensor controller 206 to provide open and closed connection states, respectively.

Referring to FIG. 8B, in the embodiment, the sensor portion 2 is a second sensor portion 2 which is short-planiform-shaped, and the sensor unit 21 has a tip end. The second sensor potion 2 is provided to measure temperature of an anus. The first switch 2041 and the second switch 2042 of the second sensor portion 2 are controlled by the sensor controller 206 to provide closed connection states.

Referring to FIG. 8C, in the embodiment, the sensor portion 2 is a third sensor portion 2, which is flat-elliptical-shaped, and the sensor unit 21 has a flat end. The third sensor portion 20 is provided to measure temperature of a tongue. The first switch 2041 and the second switch 2042 of the third sensor portion 2 are controlled by the sensor controller 206 to provide closed and open connection states, respectively.

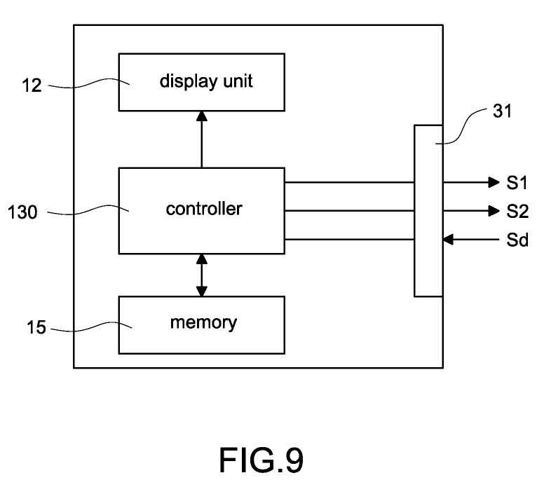

Referring to FIG. 9, the main controller 130 is electrically connected to the display unit 12 and the first connecting unit 31. Also, the main controller 130 is further electrically connected to a memory 15. When the control portion 1 is electrically connected to the sensor portion 2 to correctly use the electronic clinical thermometer, the main controller 130 sends a first switch signal S1 and a second switch signal S2 to the sensor portion 2 to detect a connection (closed or open) state of the first switch 2041 and the second switch 2042, respectively. Afterward, a measuring data Sd is transmitted to the main controller 130 of the control portion 1 from the sensor portion 2. The memory 15 has stored measuring formulas for the sensor 2 measuring armpit, anus, and tongue temperature, respectively. The control portion 1 can identify the type of the sensor 2 (for armpit, anus, or tongue) by detecting the connection states of the first switch 2041 and the second switch 2042. Further, the measured data Sd is processed by the main controller 130 with reference to the measuring formulas in the memory 15. Therefore, a correct temperature can be displayed on the display unit 12.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A replaceable electronic clinical thermometer, comprising:
a control portion, comprising:
a control unit providing functions of actuating and de-actuating the electronic clinical thermometer, switching operation modes, and changing settings;
a main controller electrically connected to the control unit, and processing a control signal transmitted from the control unit; and
a display unit electrically connected to the main controller, and displaying measured temperature data, operation modes, and operation statuses;
a memory electrically connected to the main controller and storing measuring formulas for at least one of armpit, anus, and tongue;
at least one sensor portion, comprising
a sensor unit measuring environmental temperature;
a sensor controller electrically connected to the sensor unit, and processing measured data transmitted from the sensor unit; and
a signal switching unit electrically connected to the circuit unit, and having a first switch and a second switch, which are controlled by the sensor controller for setting the connection state thereof,
wherein the main controller is adapted to receive a measured data from the sensor controller and identify a type of the sensor portion through the connection states of the first switch and the second switch;
wherein the main controller is adapted to process the measured data with reference to the type of the sensor portion and the measuring formulas in the memory, whereby a correct temperature can be displayed on the display unit.

2. The replaceable electronic clinical thermometer as claimed in claim 1, further comprising:
a connecting unit having a first connecting unit and a second connecting unit, wherein the first connecting unit being installed in the control portion and the second connecting unit being installed in the sensor portion; both the first connecting unit and the second connecting unit having a plurality of pins;

3. The electronic clinical thermometer in claim 1, wherein the sensor portions comprises a first sensor portion, a second sensor portion, and a third sensor portion.

4. The electronic clinical thermometer in claim 1, wherein the first switch and the second switch of the sensor portion are open and closed, respectively.

5. The electronic clinical thermometer in claim 1, wherein the first switch and the second switch of the sensor portion are both closed.

6. The electronic clinical thermometer in claim 1, wherein the first switch and the second switch of the sensor portion are closed and open, respectively.

7. The electronic clinical thermometer in claim 2, wherein pins of the first connecting unit and the second connecting unit are printed upon a printed circuit board.

8. The electronic clinical thermometer in claim 2, wherein pins of the first connecting unit and the second connecting unit are metal strings.

9. The electronic clinical thermometer in claim 1, wherein the sensor portion is long-slender-shaped, and the corresponding sensor unit has a tip end.

10. The electronic clinical thermometer in claim 1, wherein the sensor portion is short-planiform-shaped, and the corresponding sensor unit has a tip end.

11. The electronic clinical thermometer in claim 1, wherein the sensor portion is flat-elliptical-shaped, and the corresponding sensor unit has a flat end.
